(19) United States
(12) Patent Application Publication
(10) Pub. No.: US 2004/0146232 A1
(43) Pub. Date: Jul. 29, 2004

(54) Gothic style bearing formed with modified eyelet

(76) Inventors: Harry C. Buchanan JR., Dayton, OH (US); Yaomin Dong, Dayton, OH (US); Frederick M. Goerz, Kettering, OH (US)

Correspondence Address: YOUNG & BASILE, P.C., Suite 624, 3001 West Big Beaver Road, Troy, MI, 48084-3107, US

(21) Appl. No.: 10/352,816

(22) Filed: Jan. 28, 2003

(51) Int. Cl. F16C 33/58

(52) U.S. Cl. 384/513

(57) ABSTRACT

A gothic-style bearing defines a single circular continuous recirculating path raceway for a plurality of ball bearings to be positioned therein and to be in operable engagement with a shaft having an annular groove formed therein. The bearing includes an eyelet having a cylindrical portion, a flange portion connected to one end of the cylindrical portion, and an annular groove with a ball-engaging surface formed in a transition between the cylindrical and flange portions. Two eyelets are assembled in flange-to-flange, face-to-face relationship with respect to one another and aligned with an annular groove formed in a shaft to be supported to receive a plurality of ball bearings to be positioned therebetween.

### FIELD OF THE INVENTION

The present invention relates to a gothic style bearing and a method for producing a gothic style bearing with a modified eyelet to form a single circular continuous recirculating path raceway for receiving a plurality of ball bearings.

### BACKGROUND OF THE INVENTION

Many highly efficient motors employ Conrad bearings to achieve bearing efficiency. Conrad bearings are best suited to radial loads. The Conrad bearing has a limitation with respect to axial loads, and therefore must be sized to withstand any expected axial thrust load. Worm motor applications typically have high thrust loads, which can be calculated as (T/R) cos (PA), where T equals torque, R equals gear radius, and PA equals gear tooth pressure angle. Radial loads are approximately ⅓ of the axial load, or (T/R) sin (PA). The proper bearing for worm gear motor applications is a journal bearing. Journal bearings are costly, and are not currently capable of being manufactured in high volume production. It would be desirable in the present invention to provide a bearing structure capable of high volume production, and capable of handling both radial and axial thrust loads.

### SUMMARY OF THE INVENTION

The present invention discloses a gothic style bearing which uses a common ball set to direct both radial and axial thrust loads. By stamping and forming eyelet style raceways according to the present invention, an inexpensive gothic style ball bearing can be produced for a fraction of the cost associated with a corresponding Conrad bearing.

According to the present invention, two eyelets are manufactured with a ball groove corresponding to approximately ½ of the diameter of the ball bearings to be received. A first eyelet is placed on a shaft to one side of a ball groove formed in the surface of the shaft to be supported. A plurality of ball bearings are then assembled into the groove and eyelet groove, either in full complement distribution or in a caged configuration. The second eyelet is then placed over the shaft and locked with the opposing eyelet through interlocking locks or any other suitable means known to those skilled in the art. The entire assembly is placed into a housing having a corresponding slot or shoulder to maintain the balls in a trapped position with respect to the eyelets and shaft. The motor assembly cover according to the present invention has a flange holding feature to support the bearing from the access side. The eyelet thickness and material is selected for the appropriate finish and durability desired for the particular application.

According to the present invention, the bearing can be held at the desired location using a combination of washers and springs, or spring washers, with sufficient preload for the expected axial loads. If the axial loads exceed the spring preload, the eyelet will force the spring to deflect and act as an energy absorber for armature inertia. When the eyelets move, the balls remains trapped between the ball groove of the shaft and the eyelets. The eyelets are preloaded and retained so that the amount of travel allowed is no greater than ¾ of the ball diameter.

In a gothic style bearing according to the present invention a single circular continuous recirculating path raceway is defined for receiving a plurality of ball bearings to be positioned therein and to be in operable engagement with a shaft having an annular groove formed therein. The gothic style bearing includes an eyelet having a cylindrical portion, a flange portion connected to one end of the cylindrical portion, and an annular groove having a ball engaging surface formed in a transition between the cylindrical and flange portions. When two eyelets are assembled in flange-to-flange, end-to-end relationship with respect to one another, the combination of the annular ball grooves formed in the shaft and the two eyelets forms a singular circular recirculating rotational path raceway for a plurality of ball bearings to be positioned therebetween. In the preferred configuration, the eyelets are identical to one another. The eyelets can be formed by drawing, coining, machining, stamping, metal injection molding, and combinations thereof. The eyelets can be formed of metal materials selected from a group including steel, hardened steel, melonited steel, heat treated steel, stainless steel, spherodized stainless steel, annealed stainless steel, and heat treated stainless steel. The eyelet can be formed with a hardness of between approximately 58 R_{c} and 62 R_{c}. The annular groove in the eyelet can be formed having a ball-engaging surface finish of approximately 30 micro (μ) inches to approximately 40 micro (μ) inches.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a cross-sectional view of a gothic style bearing according to the present invention;

FIG. 2 is a cross-sectional view of a spring loaded gothic style bearing according to the present invention; and

FIG. 3 is a perspective view of an eyelet formed according to the present invention for use in assembling a gothic style bearing.

### DESCRIPTION OF THE PREFERRED EMBODIMENT

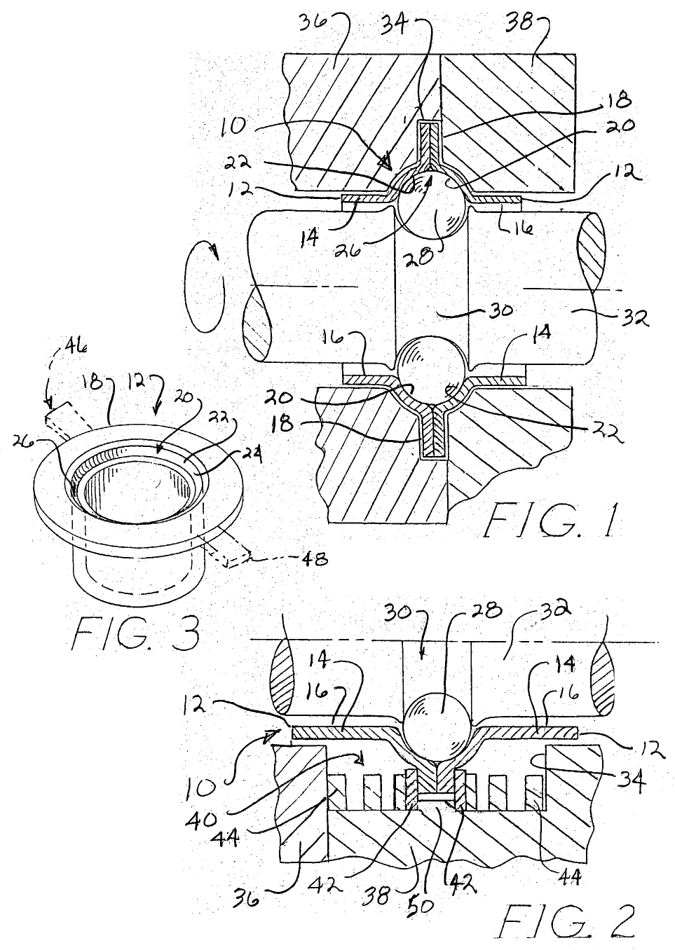

A gothic style bearing 10 according to the present invention is illustrated in FIGS. 1 and 2. The gothic style bearing 10 includes at least one, and preferably two eyelets 12. Each eyelet 12 is formed as best seen in FIG. 3. Each eyelet 12 includes a cylindrical portion 14 defining an internal bore or aperture 16 and an outwardly extending flange portion 18 connected to one end of the cylinder portion 14. An annular groove 20 is formed in a transition between the cylindrical and flange portions 14, 18. The annular groove 20 has a ball-engaging surface 22 that can be defined by a concave semi-circular cross-sectional face 24. The surface 22 can alternatively be formed of one or more angled surfaces to define the concave face 24 with at least one and preferably a plurality of ball-engaging contact points for transferring both axial and radial loads.

Referring again to FIGS. 1 and 2, the gothic style bearing 10 according to the present invention defines a single circular continuous recirculating rotational path raceway 26 for receiving a plurality of ball bearings 28 to be positioned therein when two eyelets 10 are assembled in flange-to-flange, end-to-end relationship with respect to one another and aligned with a corresponding annular groove 30 formed on a shaft 32 to be supported. The shaft 32 extends through the bores or apertures 16 formed in the coaxially aligned eyelets 12. As best seen in FIG. 1, the outwardly extending flanges 18 of each eyelet 12 can be received in an annular recess 34 formed in the housing 36 for supporting the shaft 32 and bearing 10. A cover 38 can be provided for attachment to the housing 36 trapping the flanges 18 of each eyelet 12 in an assembled condition where loads are transferred from the shaft 12 to pass through the plurality of ball bearings 28 and through the eyelets 12 into the housing 36 and/or cover 38. The eyelets 12 can be assembled with respect to one another temporarily in any suitable manner with means 46 for locking, such as by providing optional bendable tabs 48 shown in phantom in FIG. 3. Alternatively, the locking means 46 can be provided by one or more separate clips engaging the opposite faces of the flanges 18 when in the flange-to-flange, end-to-end assembled condition or with one or more spot welds through the flanges to maintain the assembled condition during further assembly of the shaft and bearing into the desired housing.

Referring now to FIG. 2, the bearing 10 according to the present invention can be mounted within a housing 36 with means 40 for preloading the bearing with a predetermined force opposing axial loads. The preloading means 40 can include a washer 42 in combination with a spring 44, or a spring washer with the desired preload force. The springs can be positioned within an enlarged annular recess 34 formed in the housing 36 or cover 38 for supporting the shaft 32. The combination of the housing 36 and cover 38 preloads the springs on either side of the flanges 18 of the two eyelets 12 in order to preload the bearing 10 against axial loads in either longitudinal direction. The preloading means 40 can be selected for the expected axial load in the particular application. The preloading means 40 can be selected to have the same preload force on either side of the flanges 18 of the two eyelets 12, or can be designed to have different preload force characteristics in opposite axial load directions. The housing 36 or cover 38 can include an inwardly extending locator 50 for defining the initial position of the flanges 18 under no load conditions, if desired.

The eyelet 12 can be formed of a metal material selected from a group including steel, hardened steel, melonited steel, heat treated steel, stainless steel, spherodized stainless steel, annealed stainless steel, and heat treated stainless steel. The eyelet 12 can be formed by drawing, coining, machining, metal injection molding, stamping, and any combination thereof. By way of example and not limitation, the eyelet 12 can be formed of 410 martensitic stainless steel. The eyelet 12 can be carburized to a hardness of between approximately 58 R_{c} and approximately 62 R_{c}. The ball engaging face 24 can be formed having a finish of between approximately 30 micro inches and approximately 40 micro inches.

A bearing 10 according to the present invention has a single circular continuous recirculating path raceway 26 for supporting a plurality of ball bearings 28 with respect to a shaft 32 having an annular groove 30 formed therein. A first eyelet 12 has a cylindrical portion 14, and flange portion 16 connected to one end of the cylindrical portion 14, and an annular groove 20 having a concave ball-engaging surface 22 formed in a transition between the cylindrical and flange portions 14, 16. A second eyelet 12 includes a cylindrical portion 14, a flange portion 16 connected to one end of the cylindrical portion 14, and an annular groove 20 having a concave ball-engaging surface 22 formed in a transition between the cylindrical and flange portions 14, 16. The first and second eyelets 12 are assembled in face-to-face, flange-to-flange relationship with respect to one another to define a raceway with a single circular continuous recirculating path for a plurality of ball bearings 28 to be positioned interposed between the eyelets 12 and the annular groove 30 of the shaft 32 to be supported by the housing 36 and cover 38. In the preferred configuration, the first and second eyelets are identical to one another.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. In a bearing defining a single circular continuous recirculating path raceway for a plurality of ball bearings to be positioned therein with respect to a shaft having an annular groove formed therein, the improvement comprising:
an eyelet having a cylindrical portion, a flange portion connected to one end of the cylindrical portion, and an annular groove having a ball-engaging surface formed in a transition between the cylindrical and flange portions, such that by assembling two eyelets in flange-to-flange relationship with respect to one another and when aligned with the annular groove formed in the shaft to be supported, a single circular recirculating rotational path raceway is defined for a plurality of ball bearings to be positioned therebetween.

2. The improvement of claim 1 wherein the eyelets are identical to one another.

3. The improvement of claim 1 further comprising:
a plurality of ball bearings inserted within the raceway during assembly.

4. The improvement of claim 1 wherein the eyelet is formed of a metal material selected from a group including steel, hardened steel, melonited steel, heat treated steel, stainless steel, spherodized stainless steel, annealed stainless steel, and heat treated stainless steel.

5. The improvement of claim 1 further comprising:
the eyelet hardened to between approximately 58 R_{c} and approximately 62 R_{c} inclusive.

6. The improvement of claim 1 further comprising:
the eyelet drawn and coined to form the annular groove in the transition between the cylindrical and flange portions of the eyelet.

7. The improvement of claim 1 further comprising:
the eyelet having a metal injection molded body with the annular groove for receiving a plurality of ball bearings.

8. The improvement of claim 7 wherein the body is injection molded of stainless steel.

9. The improvement of claim 7 further comprising:
the body carburized to a hardness of between approximately 58 R_{c} and approximately 62 R_{c} inclusive.

10. The improvement of claim 7 further comprising:
the ball-engaging surface of the annular groove having a finish of between approximately 30 μ inches and approximately 40 μ inches inclusive.

11. The improvement of claim 7 wherein the body is formed of 410 martensitic stainless steel.

12. The improvement of claim 1 further comprising:
the eyelet having a stamped body for receiving a plurality of ball bearings.

13. The improvement of claim 1 further comprising:
means for assembling two eyelets in flange-to-flange, end-to-end relationship with respect to one another to define the single circular recirculating rotational path raceway therebetween in combination with the annular groove formed in the shaft to be supported and aligned therewith.

14. The improvement of claim 1 further comprising:
two of the eyelets operably engageable in face-to-face, flange-to-flange relationship with respect to one another to define the single circular recirculating rotational path raceway passing through aligned portions of the annular grooves formed by the two eyelets and the shaft for receiving the plurality of ball bearings.

15. A bearing having a single circular continuous recirculating path raceway for supporting a plurality of ball bearings with respect to a shaft having an annular groove formed therein comprising:
a first eyelet having a cylindrical portion, a flange portion connected to one end of the cylindrical portion, and an annular groove having a ball-engaging surface formed in a transition between the cylindrical and flange portions;
a second eyelet having a cylindrical portion, a flange portion connected to one end of the cylindrical portion, and an annular groove having a ball-engaging surface formed in a transition between the cylindrical and flange portions; and
the first and second eyelets assembled in face-to-face, flange-to-flange relationship with respect to one another to define a single circular continuous recirculating path raceway for a plurality of ball bearings to be positioned interposed between the eyelets and the annular groove of the shaft to be supported.

16. The bearing of claim 15 wherein the first and second eyelets are identical to one another.

17. A process for assembling a bearing having a single circular continuous recirculating path raceway for supporting a plurality of ball bearings with respect to a shaft having an annular groove formed therein comprising the steps of:
inserting a first eyelet on a shaft to be supported, the first eyelet having a cylindrical portion, a flange portion connected to one end of the cylindrical portion, and an annular groove having a ball-engaging surface formed in a transition between the cylindrical and flange portions;
positioning a plurality of ball bearings with respect to the annular groove formed in the shaft and the first eyelet;
inserting a second eyelet on the shaft to be supported, the second eyelet having a cylindrical portion, a flange portion connected to one end of the cylindrical portion, and an annular groove having a ball-engaging surface formed in a transition between the cylindrical and flange portions; and
assembling the first and second eyelets in face-to-face, flange-to-flange relationship with respect to one another to define a single circular continuous recirculating path raceway for the plurality of ball bearings to be positioned interposed between the annular groove of the first and second eyelets and the annular groove of the shaft to be supported.

18. The process of claim 17 further comprising the step of:
at least temporarily locking the first and second eyelets after the assembling step.

19. The process of claim 17 further comprising the step of:
positioning the first and second eyelets and the shaft to be supported with respect to a housing and an associated cover, where the flanges of the first and second eyelets are enclosed within a recess.

20. The process of claim 17 further comprising the step of:
preloading the assembled first and second eyelets with force resisting an axial thrust load from the shaft to be supported with at least one spring operably associated with a flange of one of the first and second eyelets.
